(19) United States
(12) Patent Application Publication
(10) Pub. No.: US 2007/0076021 A1
(43) Pub. Date: Apr. 5, 2007

(54) Processes for inkjet printing

(76) Inventors: Edward J. Stancik, Wilmington, DE (US); Steven Dale Ittel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/241,613

(22) Filed: Sep. 30, 2005

(51) Int. Cl. B41J 29/38

(52) U.S. Cl. 347/5

(57) ABSTRACT

Processes for ink jet printing are provided. The processes are suitable for printing of highly loaded inks, on relatively non-absorbent surfaces, and can provide images having finer and/or thinner features than images printed using conventional inkjet processes and conventional inks.

### FIELD OF THE INVENTION

The present invention is directed toward processes for the inkjet printing. The processes enable the printing of thick features using highly loaded ink compositions having desirably reduced spreading and sharper or narrower features on non-absorbent substrates than conventional inks.

### BACKGROUND OF THE INVENTION

Computer-controlled printer technology allows high-resolution digital images to be printed on media ranging from graphic design on fabric and paper to electronic or display applications on glass, plastic, and ceramics. One particular type of printing (referred to generally as inkjet printing) involves the placement of small drops of fluid ink onto a media surface in response to a digital signal. Typically, the fluid ink is transferred or jetted onto the surface without physical contact between the printing device and the surface. Within this general technique, the specific method by which the inkjet ink is deposited onto the substrate surface varies from system to system, and includes continuous ink deposition and drop-on-demand ink deposition.

In continuous printing systems, a continuous stream of individual ink droplets is ejected by a printhead nozzle. The individual ink droplets are individually directed with the assistance of an electrostatic charging device in close proximity to the nozzle, to the substrate surface, or to a recycle system. In a continuous printing system, if the ink is not directed onto the substrate surface, it is recycled for later use. In drop-on-demand systems, individual ink droplets are propelled from a nozzle by heat or by a pressure wave onto the substrate surface where they are required. All of the ink droplets formed are used to form printed images.

Flexibility, low cost and high quality of output have made inkjet printing a popular form of printing. Originally aimed at the home and office market, the technology is rapidly evolving into manufacturing applications in the electronics industry. These new, more technological applications increase the demand for higher quality inkjet printing systems and methods.

Presently, regardless of the method employed to eject ink from an inkjet printer, a problem commonly experienced when printing on non-porous or non-absorbent surfaces such as glass, ceramics, metal, or plastic is that slow drying of the ink provides an opportunity for undesirable flowing of the image before the drying process is complete. This is particularly true when it is necessary to build up an appreciable layer of the ink material. When printing electrical conductors on a glass or ceramic surface, several passes through the inkjet printer may be required to deposit sufficient conductive material to achieve the low resistance desired, even when the ink is highly loaded with the conductive material.

The features on electronic parts are becoming progressively finer and more complex, increasing the demands on the resolution of printing. Printing resolution may be increased by using finer printheads and smaller droplet sizes. Unfortunately, there are physical limitations to the droplet sizes that may be obtained and as droplet size is reduced, the proportion of the active solids that may be contained in a droplet is reduced. These two features cause the rate of materials deposition to drop dramatically, when just the opposite is required for successful printing.

Several factors exacerbate the above problem. The first is that the fluid component of the ink may wet the surface, causing the droplet to spread across a larger surface area than it would have had it been absorbed rapidly into the surface. A second, closely related aspect is that drying of the droplet is much slower because it is entirely evaporative rather than being aided by absorption. This further allows a greater period of time for the droplet to be fluid and to spread on the surface by wetting.

Another exacerbating factor, especially in inks highly loaded with a high density material is that at a given drop velocity, the droplet strikes the surface with higher momentum due to the high ink density, and this higher momentum is dissipated by greater spreading of the droplet across the substrate surface.

Another factor is the relative motion of the inkjet head and the substrate. If the substrate is motionless, the droplets can hit the surface of the substrate at an angle that changes with the relative direction and velocity of the inkjet printhead. Thus the spreading of the inkjet droplet is not necessarily radially uniform. If, as is commonly the practice, the substrate is in motion, then droplets can flow relative to the substrate as the substrate is accelerated and decelerated.

Finally, speed of printing is an important feature in any printing process and in general, inkjet printing is flexible but relatively slow. It is desirable to jet as much ink as possible in the shortest period of time while maintaining the quality of the printed image.

These issues are further exacerbated when it becomes necessary to obtain appreciable thickness in one-dimensional lines or two-dimensional areas. One way to achieve the necessary thickness is to inkjet the image employing multiple passes of droplets. Overlapping drops will generally tend to flow together, thus providing electrical continuity in conductive features. However, it also provides additional fluid for undesirable flowing due to gravity or acceleration of the substrate.

In practice, the flowing of printed features is largely affected by the interaction between a variety of factors including 1) inertial or gravitational forces, 2) the viscosity of the ink, 3) the surface tension of the ink, 4) the wettability of the surface by the ink, 5) the rate of drying of the ink, 6) the loading of particles in the ink, and 7) the physical properties of the particles in the ink.

### SUMMARY OF THE INVENTION

One aspect of the present invention is an inkjet process for printing an ink composition to produce a printed image comprising:
a) preparing an ink composition comprising an ink vehicle and at least 10% by weight of an active phase;
b) printing said ink composition dropwise onto a non-absorbent substrate in an initial layer such that:
   i. in the initial layer the individual droplets do not substantially overlap one another; and
   ii. the droplets at least partially dry before printing subsequent layers; and
c) printing one or more subsequent layers in a dropwise manner such that the droplets in the first said subsequent layer are offset from the droplets of the initial layer and connect the droplets of the initial layer to form a substantially continuous network.

Another aspect of the present invention is article manufactured by a process comprising:
a) preparing an ink composition comprising an ink vehicle and at least 10% by weight of an active phase;
b) printing the ink composition dropwise onto a non-absorbent substrate in an initial layer in such a manner that:
   i. in the initial layer the individual droplets do not substantially overlap one another; and
   ii. the droplets at least partially dry before printing subsequent layers; and
c) printing one or more subsequent layers in a dropwise manner such that the droplets in the first subsequent layer are offset from the droplets of the initial layer and connect the droplets of the initial layer to form a continuous network;
d) and forming the article.

A further aspect of the present invention is a printing system for producing printed images comprising:
a) an ink composition comprising an ink vehicle and at least 10% by weight of an active phase;
b) a host device to digitally store and processes the image to be printed; and
c) a printing device comprising an input device, printer controller, print mechanism, transport device, print cartridge, and printhead; said printhead and print cartridge containing said inkjet ink composition, said inkjet printing device configured to print said ink composition onto a non-absorbent substrate in multiple layers such that;
   i. in the initial layer the individual droplets do not substantially overlap one another; and
   ii. the droplets at least partially dry before printing subsequent layers; and
   iii. one or more subsequent layers are printed in a dropwise manner such that the droplets in the first said subsequent layer are offset from the droplets of the initial layer and connect the droplets of the initial layer to form a continuous network.

These and other aspects of the present invention will be apparent to one skilled in the art, in view of the following description and the appended claims.

### BRIEF DESCRIPTION OF THE FIGURES

FIG. 1 shows the printed pattern obtained according to a process of the prior art, in which flowing of the lines in the pattern is apparent.

FIG. 2 shows a control pad after printing one pass of dots at a spacing of 60 micron between dots.

FIG. 3 shows the initial portion of a pad printed with a 110-micron spacing between dots.

FIG. 4 shows a pad after printing 2 passes with a 90-micron spacing between dots and the second layer shifted by 50 microns.

FIG. 5 shows a profilometry trace illustrating significant bulk lateral flow during printing when the spacing between drops was 75 μm.

FIG. 6 shows a profilometry trace illustrating reduced lateral flow during printing when the spacing between drops was 80 μm.

FIG. 7 shows a profilometry trace illustrating the absence of bulk lateral flow during printing when the spacing between drops was 85 μm.

FIG. 8 is a micrograph taken at 50× magnification of a single layer of silver printed on glass. The scale bar represents 200 μm.

FIG. 9 is a micrograph taken at 50× magnification of 2 layers of silver printed on glass. The scale bar represents 200 μm.

### DETAILED DESCRIPTION OF THE INVENTION

The present invention provides processes for the inkjet printing of images employing highly loaded inks, allowing reduced pad flow and/or reduced line spreading during the printing process. A process according to the invention includes preparing a highly loaded ink composition that comprises an ink vehicle and at least 10% by weight of an active phase. As used herein, the terms “ink” and “ink composition” are used interchangeably. The ink is printed dropwise onto a non-absorbent substrate in an initial layer in such a manner that in the initial layer the individual droplets preferably do not overlap one another. It is desirable that the droplets be allowed to dry before printing subsequent layers. One or more subsequent layers are then printed in a dropwise manner onto the initial layer such that the droplets in each layer are offset from the droplets of the initial layer or the previous layer and connect the previously deposited droplets to form a printed image comprising a substantially continuous network. A sufficient number of the subsequent layers are printed so that the final lines or pads have sufficient average thickness. The processes disclosed herein enable printing on non-absorbent or minimally absorbent surfaces.

It is generally preferred that the droplets in the initial layer have a smaller diameter than the droplets in subsequent layers. The composition of the ink for printing the initial layer and each subsequent layer may or may not be the same, and the active component of the ink for printing the initial layer and each subsequent layer may or may not be the same. Thus the initial layer may be printed with an ink composition that contains less silver and more polymer than the ink composition used to print subsequent layers. Alternatively, the composition of the ink for the first layer may contain solvent components that are more volatile that the solvents used for subsequent layers thereby causing the initial layer to dry more quickly than subsequent layers. Further, the ink composition for the initial layer may contain components designed to create greater adhesion of the active phase to the substrate that might be unnecessary in subsequent layers. Alternatively, using the same ink for all layers would allow the simplest printing system requiring only a single set of printheads for print all layers. The total average thickness of the printed image is greater than 0.4 micrometers and preferably greater than 1 micrometer. In some embodiments, the average thickness of each subsequent layer is greater than the average thickness of the initial layer. In some embodiments, the average thickness of the initial layer is greater than 0.1 micrometers. One or more of the layers can be subjected to photochemical curing. The printed image can be subjected to firing, particularly if the active phase is silver. The ink vehicle contains a series of components of decreasing volatility. Suitable substrates for printing include glass, ceramic, and metal.

The process of jetting an individual droplet from a piezoelectric inkjet head is controlled by a waveform programmed into the controlling computer. This waveform, dependent upon the nature of the inkjet head and the ink, consists of multiple components. With the voltage set at some initial voltage, those components include a trapezoidal rise to a dwell voltage. The dwell voltage is held as the cavity resonates and fluid is withdrawn into the inkjet head. The fall takes the voltage to a value lower than the initial voltage where the echo holds to eject the droplet. There is then a final rise back to the initial voltage so the remaining fluid is withdrawn back into the head, thereby detaching the droplet tail from the inkjet head. The timing of the three voltage levels and the two ascents and intervening descent are related through the pulse rate and the resonance properties of the inkjet head and the fluid dynamics. For any given ink, it is usually possible to find some wave forms that will give droplets of varying sizes in a reliable manner. As atmospheric or other operational conditions change, it is possible that the window of operability will move beyond the chosen waveform and satellites will appear under identical operating conditions. It is preferable to have an ink system that by its nature, has a wide operational window so that as printing conditions drift, operability is maintained. In addition to modifications of the wave forms driving printheads, it is also possible to vary the size of a nozzle on a printhead and thereby vary the quantity of ink that will be ejected.

As used herein, “ink vehicle,” refers to the fluid in which an active phase, which is a dispersed particulate solid, and a high molecular weight polymer are placed to form the ink. Ink vehicles are well known in the art, and a wide variety of ink vehicles may be used to form ink compositions that are useful in the present invention. The “ink vehicle” may be one or more common solvents or mixtures of solvents for the polymers, dispersants and other additives common to inkjetting inks and will disperse the active component particles. Solvents may be pure chemicals or mixtures of chemicals. It is useful to use mixtures of solvents, each solvent having a differing volatility to control the evaporation process. For instance, it may be useful to combine water with an alcohol or glycol to modify the rate of evaporation of the overall solvent mixture. Similarly, butyl acetate solvent may be used in conjunction with 2,2,4-trimethyl-1,3-pentanediol monoisobutyrate to modify the rate of evaporation. Such ink vehicles may include a mixture of a variety of different agents, including without limitation, surfactants, solvents, co-solvents, buffers, biocides, polymers, humectants, viscosity modifiers, and surface-active agents. Commonly used solvents include water, alcohols, diols and ethers.

As used herein, “active phase” refers to that particular component of the ink that accomplishes the ultimate purpose of the ink. For instance, if the purpose is to color, that active phase is the colorant while the other components can be present for printability, durability, or other purposes. The colorant may be one or more pigments suspended in the ink or combinations thereof. In conductive ink, the active phase may be electrically conductive metallic particles, an electrically conductive polymer, or chemical precursors to a conductive phase. If one is printing a chemical resist, the active phase is the material that will provide the chemical resistance of the printed pattern. The “active phase” may be a finely divided solid material or mixture of materials, whether inorganic or organic, suspended in the ink. The “active phase” may be a pigment for coloring, a conductive polymer for conductivity, a biocide for selectively printed biocidal activity, or a catalyst for localized catalytic activity. There may be one or more active phases in an ink.

As used herein, “dispersed particulate solid” refers to a finely divided solid material or a mixture of materials, whether inorganic or organic, dispersed in a liquid, the addition of which imparts a desired physical property to the final printed image. Those physical properties include but are not limited to color, opacity, conductivity, fluorescence, resistivity, magnetic susceptibility, and chemical or thermal resistance. If the dispersed particulate solid is included for the purpose of security marking or tamper resistance, the means of detectability may be either covert, overt or a combination of the two. The material can be dispersed in the ink medium through a variety of means well known to those skilled in the art. In color applications, the dispersed particulate solid will be any of a wide variety of pigments well known to those skilled in the art. In conductor applications the dispersed particulate solid is comprised of electrically functional conductor powder(s). The electrically functional powders in a given composition may comprise a single type of powder, mixtures of powders, alloys or compounds of several elements. Examples of such powders include but are not limited to gold, silver, copper, nickel, conductive carbon, and combinations thereof. In resistor compositions, the functional phase is generally a partially conductive oxide. Examples of the dispersed particulate solid in resistor compositions are Pd/Ag and RuO₂. In dielectric compositions, the dispersed particulate solid is generally a glass or ceramic. Examples of ceramic solids include alumina, titanates, zirconates and stannates, BaTiO₃, CaTiO₃, SrTiO₃, PbTiO₃, CaZrO₃, BaZrO₃, CaSnO₃, BaSnO₃ and Al₂O₃, glass and glass-ceramic. It is clear from this very limited listing that the range of potential dispersed particulate solids is extremely broad and highly dependent upon the intended application of the final image.

In the printing of colored images or printed text by inkjet printing, typically the inks contain only several percent of the pigment. When one is printing a conductive pattern or other image where the thickness of the image is critical to performance, it is advantageous to employ a “highly loaded ink”. As used herein, “highly loaded” means the active phase constitutes ten percent or more by weight of the ink, based on the total combined weight of all components in the ink.

The nouns “formulation” and “composition” may be used interchangeably herein.

The terms “substrate,” “substrate surface,” and “print surface,” may be used interchangeably herein, and refer to a surface to which ink is applied to form an image. Suitable substrates include paper, fabrics and textiles; polymer films such as flexible poly(vinyl chloride) films for banners or packaging or poly(vinyl butyral) films for lamination between layers of glass; relatively inflexible materials such as glass, ceramics or metals; and plastics that can range from flexible to inflexible. This paragraph is not meant to be at all inclusive, but rather is illustrative of the wide variety of materials for which the processes and compositions disclosed herein are applicable.

By “absorbent substrate” is meant a substrate for printing into which the inkjet ink is substantially able to penetrate through pores or interstices. Examples include paper and textiles. By “non-absorbent substrate” is meant a substrate for printing on which there is little to no penetration of the fluid portion of the ink into the substrate before the solvent vehicle evaporates. Examples of non-absorbent substrates include metals, glass, ceramics, and many plastics.

A “printed image” is a desired image that is printed as a combination of lines or pads and is the objective of the printing process. In general, these printed images are the result of digital design. Inkjet printing is carried out by an integrated “printing system” that comprises the ink, the hardware for physically printing the ink, the substrate on which the ink is printed, and a digital control system that instructs the hardware how and where to print the ink. Such systems are well known to those skilled in the art and familiar to the public at large as a result of their ubiquity in this modern age. In general, the ink is contained in a reservoir. The reservoir may be an independent inkjet cartridge that includes the printhead and is plugged into the printer, or it may be contained in a reservoir that is a permanent part of the printer and that is connected through a supply line to the printhead. The printer has mechanical means to translate the printhead or the substrate or both relative to one another. The desired image is inputted into the system as a digital file and the digital control system instructs the printer how to carry out the translations and when to eject droplets onto the substrate. The droplets are ejected onto the substrate in such a manner that allowing for spreading of the droplets, the desired printed image is created on the substrate.

By the term “line” is meant a pattern printed by inkjet technology that is one, or at most two rows of dots wide. In general the objective in printing lines is to make them as narrow as possible while still obtaining any desired physical property such as conductivity. The width of the line is being minimized, but in many instances, the thickness of the line in the direction perpendicular to the surface on which the line is printed is being maximized. Thus, a line is desirably one row of dots wide. A line may be straight, curved or angled. It is generally desired for the line to have smooth side-walls. By “smooth” is meant that is that there is little remaining visual evidence of the original droplets that formed the line. It is also generally desired that the line have little roughness, which means that there is little remaining visual evidence of the solid particles in the ink or irregularities from the printing process. When lines are inkjet printed by conventional techniques, they may be subject to the formation of a central valley through what is called the coffee ring effect during the drying process. The valley formation and other drying defects are generally undesirable.

Although for some applications a straight line is preferred, in general a line need not be straight. It may be curved or straight or a combination of both. Most printers can readily travel back and forth in straight lines, so printing curves is done in small rastered segments. For continuous printing of curves, often referred to as X-Y printing, more sophisticated programming may be necessary in order for the printer to accurately trace the desired shape, which generally results in slower printing.

By the term “line spreading” is meant the lateral wetting of a substrate surface by the inkjet ink when forming a spot such that the diameter of the resulting spot is substantially wider than the diameter of the droplet line that impacted the surface. When printing a line of dots, the width of the line is substantially wider than the droplets that formed the line. This becomes a significant issue in inkjet printing when attempting to print narrow lines or patterns onto non-absorbent surfaces. The droplet or fluid portion of the droplet is not quickly absorbed into the surface and therefore has the opportunity to wet the surface and expand laterally. For instance, when inkjet printing conductors onto glass substrates, evaporation is generally the only option for solvent loss and the impact and wetting of the substrate will spread the droplet despite the desire to maintain narrow line widths. Adjacent droplets that are printed very close in time and in a position to overlap will of course, flow together. As mentioned, this can be a good and essential feature of the printing process, but it may also increase the quantity of fluid available for undesirable flowing or coffee-ring evaporation. The technology disclosed herein reduces spreading of the ink on non-absorbent substrates, thereby yielding thicker, more narrow lines with less distortion.

As used herein, the term “pads” means a pattern printed by inkjet technology, composed of three or more adjacent rows of dots on a substrate surface. One of the objectives of printing pads is to achieve an area of printed material sufficient to facilitate electrical contact between the printed lines and a plug-on contact strip. They may also serve a specific electrical function in the design of piezoelectric surface acoustic wave devices. The edges of a pad may be straight, curved or angled. is generally desired that the edges of a pad have smooth side-walls and little surface roughness or unevenness, as defined hereinabove with regard to lines. Pads need not be regular in shape. For example, pads can be in the form of rectangles, circles, curves, random shapes and/or combinations thereof.

By the term “pad flow” is meant the physical flowing of accumulated ink on the substrate surface. This flowing of ink on a surface within a limited range is of benefit for producing electrical continuity in conductive features. Flowing of ink between drops also provides additional fluid causing undesirable flowing and distortion of the printed image due to gravity or acceleration of the substrate. If large areas are printed on a non-absorbent substrate, an appreciable quantity of wet ink may be accumulated and flow from one location on the printed area to another. This is particularly troublesome if the ink flows outside the desired area. It also may lead to areas in the printed image that are too thin while others are too thick. Thin areas may not conduct as required. Thick areas may be subject to mud cracking and other undesirable effects. In practice, the flowing of printed features is largely affected by the interaction between a variety of factors including: 1) inertial or gravitational forces, 2) the viscosity of the ink, 3) the surface tension of the ink, 4) the wettability of the surface by the ink, 5) the rate of drying of the ink, 6) the loading of particles in the ink, and 7) the physical properties of the particles in the ink.

As used herein, the term “initial layer” means the first layer printed directly onto the surface of the substrate. In general, for materials build-up on the surface of a device, it will be required that the image be printed in multiple passes or layers. The initial layer serves several functions. It defines the image for subsequent layers by defining the extremes of the image. It is desired in the initial layer that the droplets do not substantially overlap. The purpose of the layer is to provide a non-flowing foundation for subsequent layers. It is not required that the initial layer be of the same composition as subsequent layers. The initial layer may contain additional materials to promote adhesion between the substrate and the printed image. The initial layer will often act as a wick for solvent removal for the subsequent layers. In general it is desirable for the droplets in the initial layer to be as close together as possible without overlapping. This maximizes the quantity of printed active phase while minimizing printing distortions due to flowing. Alternatively, the droplets may overlap slightly to form a continuous pattern, but the quantity of printed ink is controlled to minimize or prevent flowing of the ink.

By the term “do not substantially overlap” is meant that in the initial layer the individual droplets can be visually identified and that flowing of ink between droplets is minimized. While it is preferred that none of the droplets touch each other, overlapping droplets are contemplated within the scope of the invention in some embodiments. For example, the droplets can be printed in overlapping pairs with no substantial overlap, or the droplets can be printed such that there is so little overlap between adjacent droplets that flow between droplets is prevented because there is insufficient fluidity in the drying ink by the time the droplets touch. In such a case, the time required for the droplets to flow into contact is approximately equal to the time required for drying. This prevents macroscopic flow while at the same time allowing contact between the drops.

With modern inkjet devices, it is possible to control droplet size by controlling the profile of the pulse used to eject the ink from the printhead. Printheads are also available with a variety of sizes of orifices, allowing the printing of different size droplets. The term “droplet size” refers to the diameter of the droplet and refers to both the droplet in flight between the inkjet head and the substrate and the resulting droplet or spot on the substrate after the droplet has impacted the substrate and wet the substrate surface. There is no requirement that the droplet sizes used to print any given portions of the printed pattern need to be the same. It is desirable to print the initial layer in which the droplets do not substantially overlap utilizing a droplet size that is smaller than the droplet size used to print the subsequent layers. Larger droplet sizes may be employed to deliver the ink more rapidly in subsequent layers to connect the initial droplets to one another on the same layer and/or to drops in a subsequent layer and to increase the thickness of the printed pattern as quickly as possible. The initial smaller droplets will serve to limit the flow of the larger droplets in subsequent layers. There is also no requirement that the initial and subsequent layers be printed with the same printheads or with the same ink.

Differentiation of the deposition of the first layer from subsequent layers is not limited to regulation of the droplet size delivered to the substrate in the initial or subsequent layers. As noted above, it is desirable to deposit the initial layer in such a manner as to minimize flowing. Subsequent layers build the layer of material delivered on surface. As an alternative to larger or smaller droplets, the density of droplets on the substrate surface may be varied. Thus, in subsequent layers, the droplets may be spaced closer together to deliver more ink to the surface, desirably maintaining the definition of pattern set by the initial layer.

By the term “subsequent layers” is meant each of the layers that are printed subsequent to the initial layer. The subsequent layers are desirably printed in a manner so as not to distort the image produced by the initial layer, but the subsequent layers are generally meant to provide more material to the image than the initial layer. Thus the droplet size may be larger, the ink may contain more active component, and/or the droplets may be closer together, thereby providing more material to the image.

As used herein, the term “dry” means that the ink is no longer capable of flowing or has a substantially reduced ability to flow under the acceleration and deceleration of translation. This may be the result of some, if not most of the ink medium being evaporated. The medium will generally contain not only a base solvent, but also one or more higher-boiling solvents to control the drying process. Those higher-boiling components are not necessarily evaporated before any of the subsequent layers are printed, but it is desirable that an appreciable fraction, probably half or more, of the solvent be evaporated before depositing another layer of droplets to increase the viscosity of the printed image.

An alternative process for ink drying is to include in the ink photoactive components that will lead to curing of the ink through crosslinking reactions. Photo-curable inks are well known those skilled in the art. The photocuring process may be through free radical generation or photoacid generation. If the printed image can no longer flow as a result of any of these or other mechanisms, it can be considered to be dry.

As used herein, the term “offset” means that one layer of dots is not printed directly on top of the previous layer of dots. In a line, subsequent layers may be printed between the initial layer of dots to form a continuous line. On a pad, the initial layer may have been printed, for instance, in a hexagonal array. The next layer can be printed in another hexagonal array offset from the original array to fill in half of the interstices. A subsequent layer will be offset in such a manner as to fill in the other set of interstices providing what would be described as a hexagonal close packed array. While the hexagonal close packed array provides the greatest quantity of ink in the shortest time with the best opportunity to dry and the least flowing, square arrays are often more convenient to program into the inkjetting device. In very small, complex patterns, the optimized printing pattern may take into consideration the drop sizes, the drop centers relative to the desired pattern and spacings, the drying time between subsequent layers, shortening the printing time and the machine capabilities, because changes in direction or velocity of a printhead or substrate are time consuming.

By the term “connect” is meant the flowing together or overlapping of droplets to form a continuous image. Flowing together or overlapping in a single layer can lead to undesirable flowing or distortion of the printed image and is therefore generally not desired. It is preferred that an initial row of discontinuous droplets is connected when a subsequent layer of printing overlaps the consecutive droplets.

As used herein, the term “continuous network” refers to a printed pad in which all of the droplets in the printed image are connected. A continuous network does not necessarily imply that the entire surface is covered. For instance, a chicken-wire pattern of connected dots may provide sufficient electrical conductivity on a surface while saving on the use of precious silver and printing time. The use of a continuous but open network rather than a uniform coating may have a variety of advantages. If printing a precious metal, the quantity of metal could be reduced, but this will require careful consideration of the electronic response. Printing times could be substantially reduced. Sequential printing of different materials, for instance a conductor and a dielectric, could yield higher capacitance in a smaller area.

When a series of dots are printed, the thickness of the dots can be non-uniform and between the dots there is no material and therefore no thickness. Nonetheless, modern profilometry instruments are capable of measuring and expressing the average thickness over a sloped line or rough pad and the techniques are known to those skilled in the art. As used herein, the term “average thickness” means a measured thickness of material printed in any given layer. Thus a series of alternating filled squares and equal sized blank spaces has an average thickness exactly half the thickness of the squares. The concept of average thickness is more complicated for dots or lines, which have profiles more like a hill than a square wave. The thickness of a particular layer or the cumulative thickness of any number of subsequent layers can be determined using modern profilometric techniques.

As used herein, the term “firing” refers to a process of heating of the printed image through a particular temperature profile to achieve enhanced performance in certain desired properties. For example in the printing of silver conductors, the firing process may be to remove residual organics from the ink, to sinter the active phase particles into a continuous lines, or to adhere the printed image to the substrate surface. Printed silver images are sintered at temperatures ranging from 150° C. for images on plastics to 400° C. for images on glass to 900° C. for images on ceramics. The sintering temperatures are dependent upon the nature of the active phase, the substrate, and the desired properties of the ink when printed. While the heating may be accomplished using a variety of methods and devices, it is generally accomplished by passing the printed object through an inert atmosphere belt furnace having a preset heating and cooling profile. A typical profile for an image printed in silver of nanometer size would start from room temperature and heat at 1-5° C./min to 160° C. where the temperature would hold for 30 minutes. The temperature would then be increased at the same rate with similar 30 min holds at 190, 220, and 250° C. before cooling back to room temperature. For large particle silver inks, the highest temperature would range from 300 to as high as 600° C. There are instances where temperatures as high as 900° C. would be employed, but the thermal profiles would be similar in nature.

A “surface acoustic wave” (“SAW”) is a sound wave that propagates along the surface of a solid of an elastic piezoelectric device. It is also called a Rayleigh wave and has both longitudinal and transverse (shear) components. Such surface waves are used in hybrid electroaccoustic devices for such purposes as signal amplification and recognition, the scanning of visual information and the delaying of fast electrical signals. SAW chips are employed in the creation of filters, oscillators and transformers based on the acoustic wave's transduction from mechanical energy to electrical energy or from electrical energy to mechanical energy.

Depending on the desired application or end use of an ink, different quantities of ink or components thereof are sufficient and effective for the desired application or end use. For example, an effective amount of an “ink vehicle” is the minimum amount required in order to create ink, which will meet the specified performance and characteristic standards. Additionally, the preferred amount of an “active phase” is the minimum amount that can still achieve the specified performance and characteristic standards. When silver is printed, “sufficient silver” may be the amount of silver required in a printed line to achieve desired conductivity for a plasma display device, for example.

Inks currently under development for the electronics and other industries are beginning to rely on solids contents greater than those traditionally used for inkjet inks. The high solids contents allow the properties of the solids to be imparted to a printed surface in less time since more material is transferred with every printed drop. Some examples of materials under exploration include metal particles to impart conductivity and ceramic particles to impart structure. Because the properties of these inks are different from traditional inkjet inks, and because the goals sought with these inks are different from those sought with traditional inkjet inks, a number of advantages can be gained by development of new printing schemes and redevelopment of traditional printing schemes.

For example, a traditional inkjet ink image is printed over a surface by moving the printhead back and forth while the substrate is moved in the perpendicular direction. There is no reason to print an area more than once. There is no advantage to printing in a different direction. For new high-solids inks, part of the goal is to build up thickness in a printed area. This could increase conductivity, for example, when a metal nanoparticle is printed. The high solids contents of these inks, however, often create reliability issues during printing, and particularly during printing of the first few drops in a printed row. Thus, when good edge definition is critical, such as in printed electronics, it would be advantageous to print in the direction perpendicular to the critical dimension, such as a gap between two conductive areas, for example. A second print of the same row in the reverse direction could also ensure that any areas left open by misfires in the first print are covered by the second print. This scheme eliminates the reliability issue created by misfires that often occur during the first few pulses by printheads jetting high solids content inks.

Thickness, and related properties like conductivity, can be controlled in much the same way that visual properties like color density are controlled in traditional inkjet printing. Using this scheme, a single print can provide a controlled variation in electronic, thermal, or structural properties, as examples, across a printed area. Alternatively, the printing scheme can be used to control some of the problems that occur with the development of thickness with high solids content inks. The spacing between drops can be increased near areas, such as where critical gaps are defined, where ink flow after printing could result in loss of performance. The spacing between drops can be decreased in other areas where a high degree of the functionality offered by the solids is desired. As another application, macroscopic ink flow can be controlled by printing a pattern of alternating thin and thick areas in one layer, and then printing the inverse pattern in a second layer, to obtain uniform thickness across the entire area. Ink may bead up in the thickly printed areas within a given layer, but flow can be prevented by the barrier provided by the thinly printed areas.

In the printing of lines in some applications, it is desired that the lines be as narrow as practically possible. In the printing of silver inks to achieve electrically conductive lines, it is also desirable to achieve sufficient line thickness so that the conductivity of the lines is sufficient for the application in mind. On non-absorbent surfaces, this can present a dilemma in that as one attempts to deliver more ink to make the line thicker, the surface will be wetted and the line will spread rather than get thicker. One solution is to print the line in multiple passes, but it is possible to achieve greater control over the profile of the cross section of the line using an improved printing strategy. Nonetheless, the conductivity of the line will be a function of the cross sectional area of the line and that is related to the total ink and resulting silver delivered to the line. This strategy may be implemented in such a manner as to optimize not only the profile of the line, but also the effective printing speed of the system by allowing an improved delivery of ink to the line.

An exemplary embodiment of a process that utilizes a strategy of minimizing line width follows. The width of a line is a function of the diameter or volume of the delivered ink droplet, the impact of that droplet on the substrate surface, the wetting of the surface, and/or the drying time of the droplet. By delivering the smallest possible droplet, the diameter of the droplet is minimized, the quantity of ink to wet the surface is minimized, and the drying time of the droplet is minimized. However, the printing speed also is generally minimized when a minimal size droplet is delivered. Incorporation of polymers in the ink can serve to minimize the spreading of the ink also. By printing a discontinuous rather than overlapping series of dots in a line, the ink is allowed to spread in two dimensions rather than only one, so the effective width of the line is diminished. The first row of printed dots, when dried or partially dried, serves as a wick for a second layer of dots because the dots are generally more absorbent than the substrate. Thus, printing a second pass of dots to connect all of the initial dots, thereby generating a continuous line, allows the ink of the second pass to flow preferentially into the ink in the dots of the first pass, thereby maintaining the narrow features of the line. Evaporation of solvent from the initial row of dots will have concentrated any polymer and active component present. The solvent of the second row of dots may redissolve the polymer from the initial row, increasing the viscosity of the ink even before any evaporation occurs. This rapid increase in viscosity can minimize flowing of the ink and spreading of the line. Subsequent layers of dots may be printed at a higher ink delivery rate whether with higher droplet volumes or closer droplet spacing, and yet be contained within the width of the initially printed line. The result is that a narrower but thicker line may be printed with higher printing speed.

This approach may be further modified to advantage, because the sequential layers of ink need not be of the same composition. For instance, purposely modifying the composition of the first layer to maximize the absorbance will help spread the subsequent layers in the direction of the printed line rather than spreading outside the initially printed width to make the line wider. Having an increased polymer concentration or a polymer that will impart higher viscosity to subsequent layers of ink will minimize the rate of spreading of the ink, thereby minimizing the width of the lines. The initially printed line may contain reactive species that react with components of the subsequent lines to gel or solidify the ink before it can spread; these reactions would most likely be crosslinking reactions of the polymeric components to build high molecular weight. The initially printed line may contain catalytic species that catalyze a reaction of components of the subsequent lines to gel or solidify the ink before it can spread, such as a Lewis-acid or protic acid catalyst that is able to mix or diffuse in the fluid inks.

The initially printed line may contain adhesion promoters to increase adhesion of the printed line to the substrate. By locating the materials at the interface of the substrate and the line, and not in the higher levels of the line, they would provide the highest level of functionality at the lowest overall concentration. These adhesion promoters can often reduce the conductivity of a line because they are present at the interface between conductive particles, thereby limiting conductivity, therefore minimizing their presence in the higher levels of the line would be an advantage.

An inkjet printer is a device for directional and positional deposition of droplets of ink or other materials in a pattern-wise manner and such devices are well known to those skilled in the field as well as by the general public. The portion of the printer actually ejecting the droplets is referred to as an inkjet printer head and the orifice from which the ink is ejected is referred to as the printhead nozzle or simply nozzle. Inkjet printheads can be either a thermal inkjet device or a piezoelectric inkjet device depending upon the mechanism for the ejection process. Again, this differentiation and the availability of other printing methods are well known to those skilled in the art.

One embodiment of the present invention is a method of printing an image on a substrate with reduced pad or line flow around the image. The method comprises formulating an inkjet ink composition comprising an effective amount of an ink vehicle, an effective amount of a dispersed particulate solid, and the other additives required to formulate a highly loaded inkjet ink. The inkjet ink composition is jetted from an inkjet device, wherein the droplets are initially printed in a discontinuous pattern and then the pattern is made continuous by printing one or more additional sets of droplets in patterns that are offset from the original set.

A further embodiment of the invention is a system for producing inkjet ink images having reduced pad flow comprising an inkjet ink composition having an effective amount of an ink vehicle, an effective amount of at least one dispersed particulate solid, and an effective amount of a high molecular weight polymer. An inkjet device containing the inkjet ink composition is configured to jet the inkjet ink composition onto a substrate in a discontinuous pattern and then the pattern is made continuous by printing one or more additional subsequent layers of droplets in patterns that are offset from the original set.

A description of one exemplary embodiment of an inkjet printing system of the present invention follows. The inkjet printing system of the present invention allows digital images to be printed on the substrates. In one exemplary embodiment, the inkjet printing system includes a printer portion having at least one print cartridge installed on a scanning carriage. The printing portion includes a substrate holder. As the substrate is stepped through a print zone, the scanning carriage moves the print cartridge across the substrate. The printer portion selectively activates drop generators within a printhead portion of the print cartridges to deposit ink on the substrate.

The present invention is applicable to printing systems that make use of various types of print cartridges such as those which include a printhead portion and a separate ink container portion, spaced from the printhead, that is used to either continuously or intermittently replenish the printhead portion with ink. The ink in the system is highly loaded with the active phase material plus other ink components.

The ink cartridge includes a printhead portion that is responsive to activation signals from the printing system for selectively depositing ink on the substrate. In the exemplary embodiment, the print cartridge includes a plurality of electrical contacts that are disposed and arranged on the print cartridge so that when properly inserted into the scanning carriage, electrical contact is established between corresponding electrical contacts associated with the printer portion. In this manner, activation signals from the printer portion are provided to the inkjet printhead for ejecting ink. The inkjet printhead can be either a thermal inkjet device or a piezo inkjet device.

The information source is a host device and digitally stores and processes the image to be printed. The host is a computer, processor or any other device that provides an image to be printed to the printing system. The image provided by the host is in one of a number of types, such as, an image description using an image description language or a bit map image. Some examples of the host are a personal computer (PC) or an internet link for directly receiving image information from an internet source.

The printer portion of the device includes an input device for receiving information from the host and a storage device for storing image information. The printing device further includes a printer controller capable of selectively receiving image information from each of the input device and the storage device. The printer controller provides image information to the print mechanism. The print mechanism provides control signals to a substrate transport device for transporting the substrate through the print zone. In addition, the print mechanism includes a carriage transport device for controlling movement of the carriage through the print zone as the printer controller selectively activates the inkjet printhead on the cartridges to selectively form images on the print substrate.

Although, the printing system is described herein as having a printhead that is disposed in a scanning carriage, there are other arrangements of achieving relative movement between the printhead and substrate. For example, the printing system can also be configured to have a fixed printhead portion and wherein the substrate is moved past the fixed printhead. Another example is where the substrate is fixed and the printhead is moved past the fixed substrate.

The input device receives the image information from the host and converts this image information into a format suitable for the printer controller. The input device typically performs various process functions as well as buffering functions on image information prior to providing this information to the printer controller.

Also within the scope of the present invention are articles manufactured by processes that include the printing processes disclosed herein. Examples of articles that can be made include display devices, piezoelectric devices, digitizer tablets, display screens that are sensitive to the touch of fingers or pointers, electromagnetic interference shielding devices, or piezoelectric motors. The display devices may be plasma display panels, field emission displays, or liquid crystal displays and the information electrodes and their connector tabs would be printed by the means described herein. The processes described herein may also be utilized for the printing of vias, phosphors, resistors, capacitors and other components necessary for display manufacture.

The methods described herein may be used to print the electrodes on piezoelectricly active substrates to manufacture piezoelectric devices such as SAW radio frequency band pass filter, SAW radio frequency identification tags, duplexers and multiplexers, clock oscillators, crystal resonators, fuel level sensors, dry powder level sensors, or impact detectors. The method is not limited to conductive features. In fact, it may be employed to print the piezoelectric material onto an inactive substrate. While single-crystal piezoelectric materials are most responsive to electrical stimulation, non-oriented materials display sufficient activity for many applications. Control of the thickness and orientation of the piezoelectric material is critical and the methods described herein allow greater control over the printing process.

The printing of active phase materials by the process described herein may be employed in one or more steps in the manufacturing process of the articles described, but the devices for which the approach would be applicable are seldom simple enough that the process described herein are the only ones required. The other steps of the manufacturing processes are conventional processes known to those skilled in the art and can be modified depending upon the articles being manufactured.

### EXAMPLES

The jetlab® and jetlab II® printers are manufactured by MicroFab® of Plano, Tex. The silver nanoparticles used in the formulation were AgSphere®-2 from Sumitomo Electric USA, White Plains, N.Y. Diethyleneglycol and PEG 1500 are available from Aldrich Chemical, St. Louis, Mo. Sonication was carried out in a Branson Untrasonics (Danbury, Conn.) Digital Sonifier with a CE converter set at power level 4 with an ice/water bath for cooling. Dowanol® DB was from Dow Chemical, Midland Mich. Filtration was carried out with Whatman 2.7 micron glass microfiber GF/D cat. NO. 6888-2527 (Whatman plc, Brentford, Middlesex, UK), followed by an OSMONICS® Cameo® 25NS nylon pore size 1.2 micron DDR12025S0 (Osmonics®, a subsidiary of General Electric Company, Fairfield, Conn.). Viscosities of the inks were measured at a shear rate of 76.8 s⁻¹ on a Brookfield DV-II+Pro Viscometer (Brookfield Engineering Laboratories, Middleboro, Mass. 02346-1031, USA) using the CPE-42 spindle (Shear Rate (s⁻¹)=3.84×Rotation Rate (rpm)). Surface tensions of the inks were measured on a KSV Sigma-70® tensiometer (KSV Instruments Ltd., Höyläämötie 7, FIN-00380 Helsinki, Finland).

### General Ink Formulation and Printing

The components of the ink were added to a pear shaped flask and then stirred with a spatula to bring about mixing. The disrupter horn of a Branson probe sonifier was inserted into the flask such that it was partially immersed in the mixed fluid. An ice bath was positioned around the pear shaped flask such that any heat generated during sonication would be removed. The sonifier was activated in a pulsed mode with the duration and strength of pulses increasing from 0% to 100% and 5 W to 20-25 W respectively over the course of a 5 minute time period. The sonifier was then left in continuous (100%) mode at 20-25 W for a period of 30-45 minutes. The pear shaped flask was then removed from the ice bath, and the disrupter horn was removed from the pear shaped flask. The fluid was gently swirled in the flask to incorporate any solids around the fluid edge into the fluid, and a spatula was used to stir and loosen any solids that may have settled to the bottom of the flask. The disrupter horn was then reinserted into the flask, while the flask was repositioned in the ice bath for a second sonication period of 30-45 minutes at 20-25 W in continuous (100%) mode. Upon completion, the disrupter horn was removed from the sample, and the flask was removed from the ice bath.

The sample fluid was then transferred to a syringe, which was used to push the material through a series of 2 filters. The first was a glass fiber filter with a pore size of 2.7 microns while the second was a nylon filter with a pore size of 1.2 microns. This solution would then form the stock ink for a number of printings. Prior to printing, the portion of the stock solution to be used was filtered once again through a 1.2 micron nylon filter into the inkjet reservoir. The material was then placed under vacuum for approximately 15-30 minutes to remove any dissolved gases.

Print conditions were typically set as follows: Rise: 1-3 microseconds, Dwell: 3-8 microseconds, Fall: 1-3 microseconds, Echo Dwell: 3-8 microseconds, Final Rise: 1-3 microseconds, Dwell Voltage: 30-50V, Echo voltage: (−50)-(−30)V, Frequency: 400-1000 Hz, and Stage Speed: 20-100 mm/s. These setting typically gave drop velocities in the 2-3 m/s range. The print nozzle was typically held at a distance of approximately 1 mm from the surface to be printed. The nozzle itself usually had an orifice diameter in the 30-50 micron range. While the above settings are typical, printing could be accomplished outside the listed ranges with larger time periods typically giving larger drop sizes.

### Example 1

### Control Printing

An ink comprising 50% Sumitomo Silver Powder, 0.5% Silwett L77 surfactant, 3% PEG 200, 6.5% Dowanol DB, and 40% water was formulated. The resulting mixture was sonicated for 30 min (Branson Digital Sonifier with a CE converter set at power level 4) with an ice/water bath for cooling. There were no detectable remaining solids and the suspension was filtered through the Millipore and Osmotics filters. The ink was degassed under vacuum for 30 min and then printed on a glass substrate using a Microfab Jetlab I inkjet system utilizing the control software available with the printer. A series of overlapping dots were printed in consecutive overlapping rows at high speed.

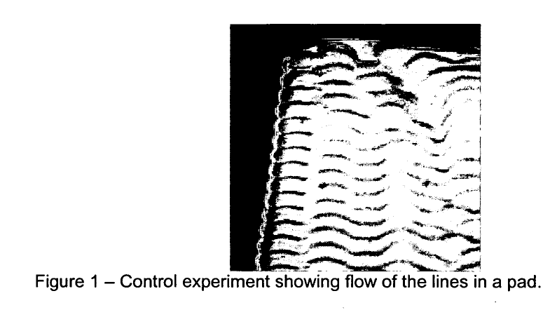

Microscopy of the resulting image (FIG. 1) showed that there had been considerable flowing of the image as a result of the acceleration and deceleration of the substrate on the table of the printer.

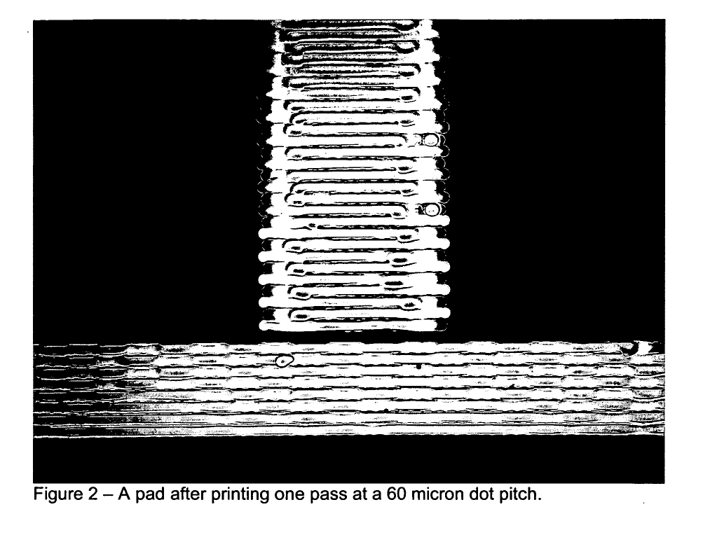

FIG. 2 shows a pair of pads printed in a very similar manner. The pads were printed at a 60 micron dot pitch so that there was overlap of adjacent drops. Acceleration and deceleration of the substrate during translation was primarily in the horizontal direction, so most of the flow between dots occurred in the horizontal direction. There was some time between horizontal rows for the ink to partially dry, so there was far less flow in the vertical direction.

### Example 2

### Printing Non-Continuous Patterns

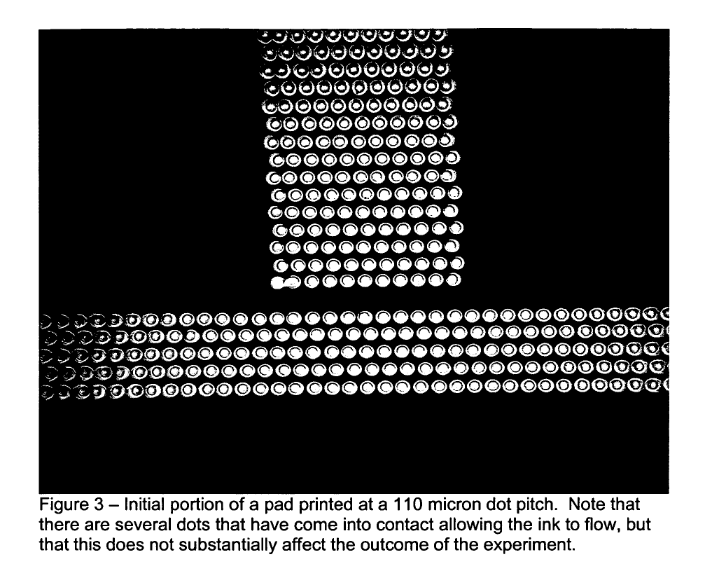

Example 1 was repeated with new settings on the MicroFab printer. Dots of approximately 100 micron diameter were printed at a spacing of 110 microns between dots. A microscopic image is presented in FIG. 3. It is clear that the dots were printed far enough apart to give a non-continuous image.

### Example 3

### Printing Offset Patterns

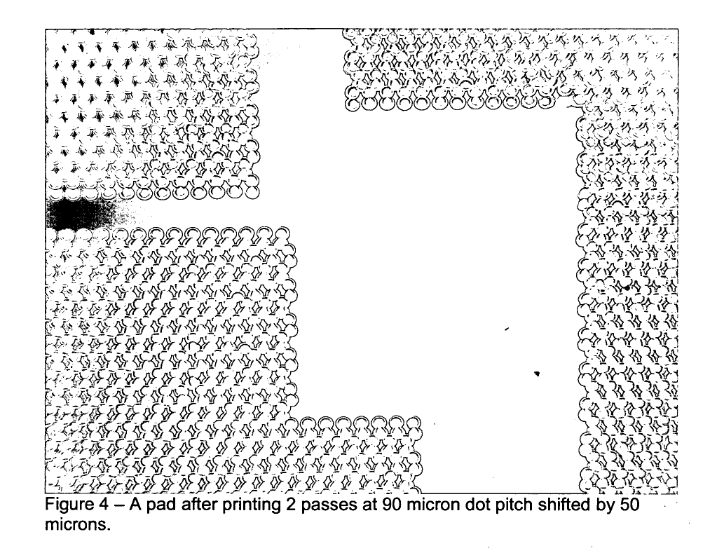

Example 1 was repeated with new settings on the MicroFab printer. Dots of approximately 80 micron diameter were printed at a spacing of 90 microns between dots. A second layer of dots shifted by 50 microns from registration with the first layer was then printed. The resulting image clearly demonstrates that there was no flowing of the image while it was wet. A microscopic image is presented in FIG. 4. It is clear that the initial dots were printed far enough apart to give a non-continuous image and that the second layer connected all of the dots. The image also illustrates the possibility of preparing an electrical contact pad that has full electrical continuity but does not require the entire surface to be covered with silver. A third layer of dots would have been sufficient to provide complete coverage of the pad area.

### Example 4

### Illustration of Drying Issues and Flow

There can be variation of print reliability with changing ambient humidity, variation of surface thickness over printed areas, defect development during firing, surface roughness development during firing, and crack development during firing.

Drying of ink on the print nozzle becomes a more serious problem as the ambient humidity drops with the change of season or geography. One solution can be to control humidity in the print station by artificially raising relative humidity. A second approach relies on the addition of ethylene glycol, a humectant, to the ink formulations. Both approaches are successful in reducing drying on the printhead, but both increase the ink drying time on the substrate leading to increased ink spreading on the printed substrates. While surface energy drives the spreading, it is facilitated by the above changes because each creates a condition that causes the ink to dry more slowly. Inks that do not dry quickly after printing, at least to some extent, also have the potential to be easily influenced by external forces, such as machine movement involved with rastering for example. This very movement is at least partly responsible for buildup of ink on one end of solid square areas printed with the MicroFab printer.

An increase in the spacing between droplets during printing seems to be an effective counter to this phenomenon. For an explanation, one must first remember that the lower limit of droplet spacing is to print one on top of another. Under this condition, the drying time during printing is very long, and any movement of the substrate can cause the ink to move from its original printed location due to inertial effects. At the other end of the spectrum, the upper limit of droplet spacing is to print discrete drops that do not contact each other. Under this condition, the smallest possible amount of ink is isolated. As a result of the small volume, the drop dries quickly, which reduces the ability of external forces to cause movement. Furthermore, the unprinted areas between droplets provide resistance to macroscopic flow.

An ink consisting of 50% Sumitomo Silver Powder, 35% PEO 300000 solution (2 g/dL in water), 5% PEG 200, 5% Dowanol® DB, and 5% ethylene glycol was formulated. Sonication was carried out for 2 periods of 40 minutes at a setting of 5 on a Branson 450 Sonifier, which results in approximately 23 W of energy being applied to the material. The resulting ink had a viscosity of 28.4 cP when measured at a shear rate of 76.8 s⁻¹ on a Brookfield viscometer. It had a surface tension of 33.4 mN/m when measured on a KSV tensiometer. Printing was carried out at the following settings: rise: 8 microseconds, dwell: 4 microseconds, fall: 8 microseconds, echo dwell: 4 microseconds, final rise: 8 microseconds, dwell voltage: 36V, echo voltage: −36V, frequency: 800 Hz, and nozzle diameter: 50 microns. A series of 5 mm square pads were printed with dot pitches of 75 μm, 80 μm and 85 μm.

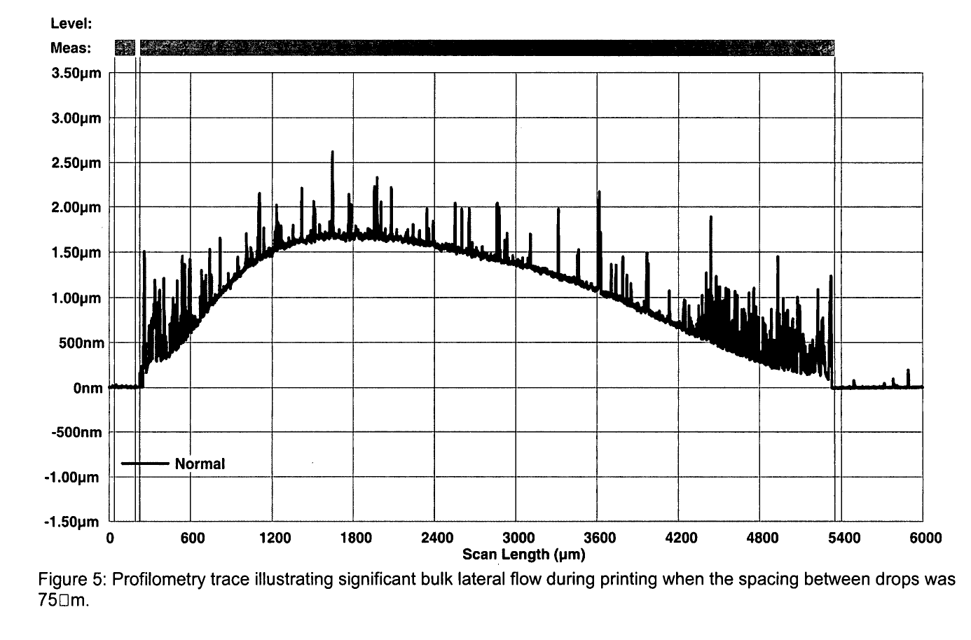

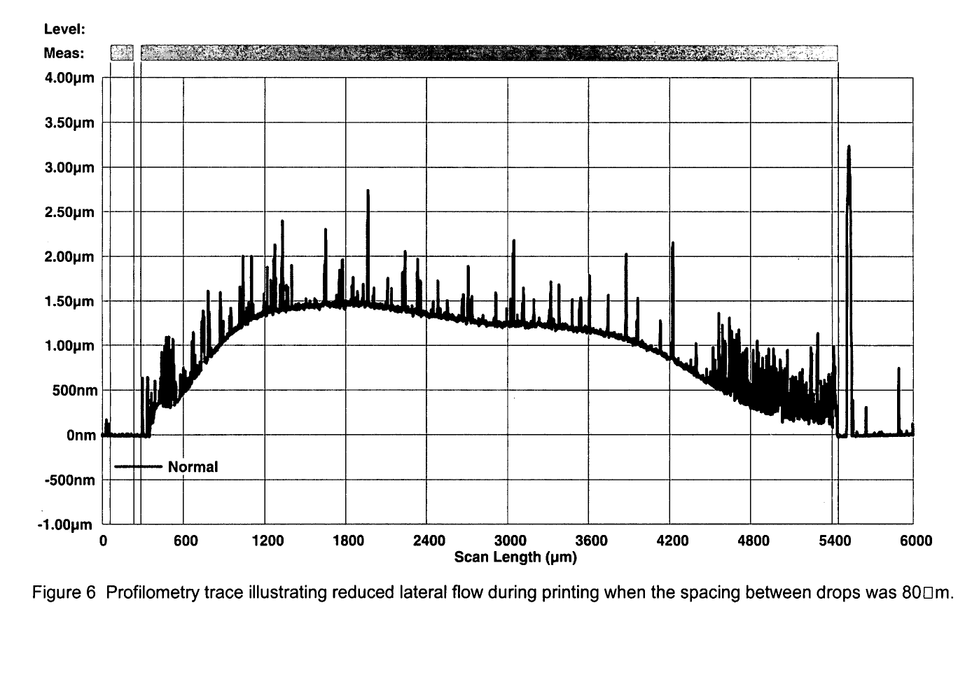

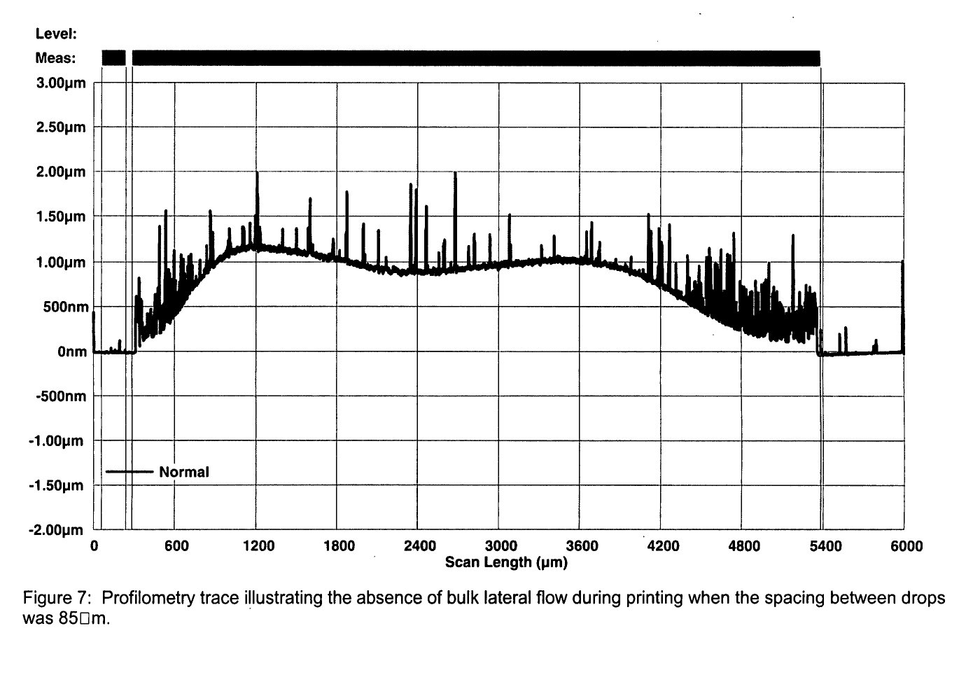

Profilometry traces of those three pads are shown in FIGS. 5, 6 and 7 respectively. The series of traces clearly demonstrate bulk lateral flow of the ink during the printing process. The bulk lateral flow is decreased significantly when the spacing between drops is increased from (FIG. 5) 75 μm to (6) 80 μm and finally to (7) 85 μm.

### Example 5

### Illustration of the Consequences of Flow

An ink was formulated with 50% Sumitomo Silver Powder, 40% PEO 300000 solution (2 g/dL in water), 5% PEG 200, and 5% Dowanol DB. The mixture was sonicated for 2 periods of 40 minutes at a setting of 5 on a Branson 450 Sonifier, which results in approximately 23 W applied to the material. The resulting ink had a viscosity of 18.7 cP when measured at a shear rate of 76.8 s⁻¹ on a Brookfield viscometer.

Printing was carried out at the following settings: rise: 3 microseconds, dwell: 4 microseconds, fall: 3 microseconds, echo dwell: 4 microseconds, final rise: 3 microseconds, dwell voltage: 35V, echo voltage: −35V, frequency: 400 Hz, and nozzle diameter: 50 microns.

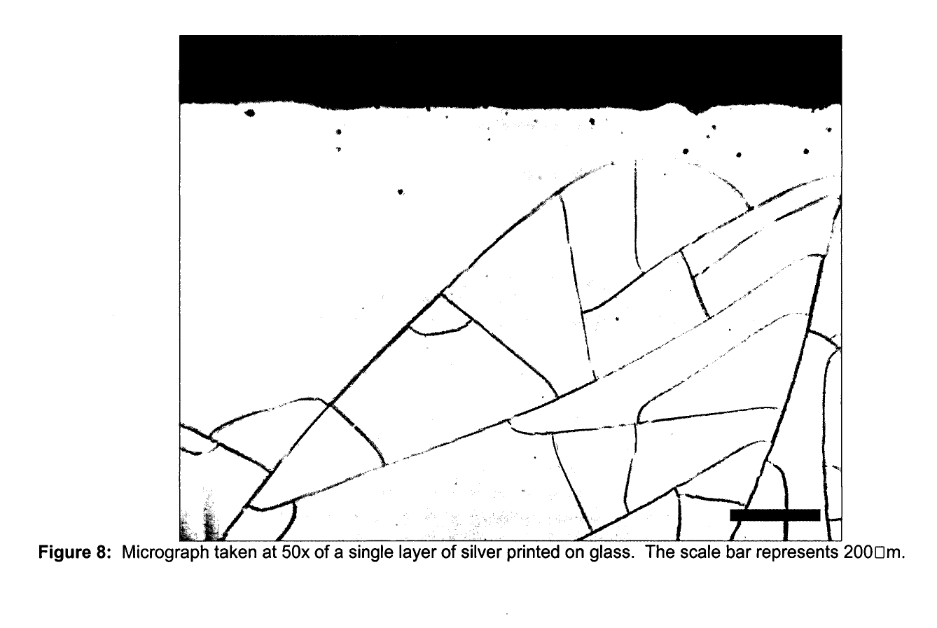

Two patterns were printed on glass. The first image was printed as a single layer with drops spaced at 50 μm. FIG. 8 is a micrograph taken at 50× of that single layer of silver printed on glass. The scale bar represents 200 μm. The small drop spacing allowed macroscopic flow of the silver ink and thus buildup of material at one end of the printed area. Drying of the thick area in a single step led to mud-cracking, a serious drying defect, and loss of adhesion of the layer.

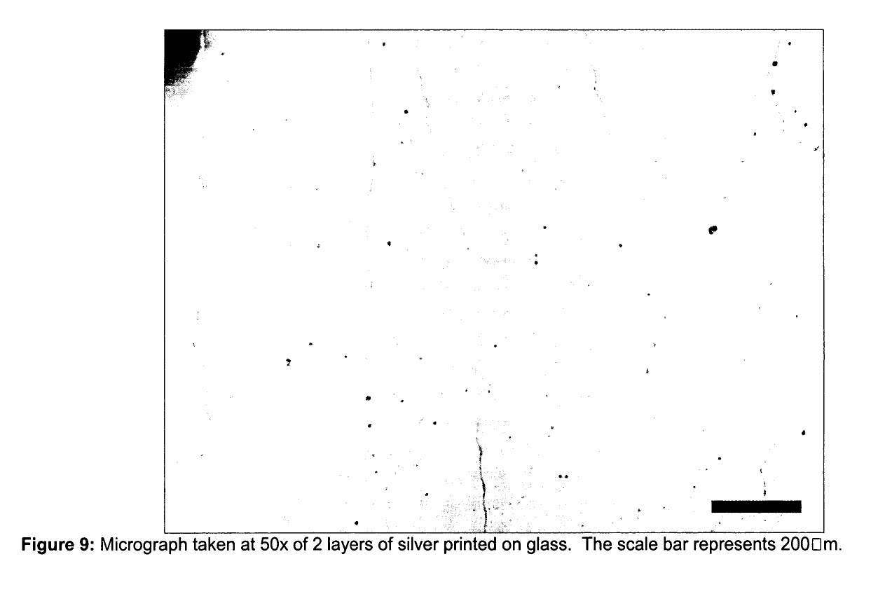

The second image was printed in two layers. The first layer was printed with drops spaced at 100 μm while the second layer was printed with drops spaced at 70 μm. Using two layers with a larger drop spacing prevented macroscopic flow during buildup to the desired pad thickness despite the fact that more ink was applied to the surface. FIG. 9 is a micrograph taken at 50×. It is observed that as a result of the printing approach, areas of uncontrolled thickness were eliminated along with the associated cracking that would occur during drying.

These two figures illustrate control over the thickness of printed areas by building up layers consisting of drops that are spaced from one another so as to facilitate drying and prevent macroscopic flow.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

What is claimed is:

1. An inkjet process for printing an ink composition to produce a printed image comprising:
a) preparing an ink composition comprising an ink vehicle and at least 10% by weight of an active phase;
b) printing said ink composition dropwise onto a non-absorbent substrate in an initial layer such that:
i. in the initial layer the individual droplets do not substantially overlap one another; and
ii. the droplets at least partially dry before printing subsequent layers; and
c) printing one or more subsequent layers in a dropwise manner such that the droplets in the first said subsequent layer are offset from the droplets of the initial layer and connect the droplets of the initial layer to form a substantially continuous network.

2. The inkjet process of claim 1 wherein said droplets in the initial layer have a smaller diameter than those printed in subsequent layers.

3. The inkjet process of claim 1 wherein the composition of the ink for printing the initial layer and each subsequent layers is different.

4. The inkjet process of claim 1 wherein the active component of the ink for printing at least one subsequent layer is different from the active component of the ink for printing the initial layer.

5. The inkjet process of claim 1 wherein the ink composition for printing the initial layer and subsequent layers is the same for each layer.

6. The inkjet process of claim 1 wherein the total average thickness of the printed image is greater than 0.4 micrometers.

7. The inkjet process of claim 1 wherein the total average thickness of the printed image is greater than 1 micrometer.

8. The inkjet process of claim 1 wherein one or more of the layers is subject to photochemical curing.

9. The inkjet process of claim 1 wherein the average thickness of each subsequent layer is greater than the average thickness of the initial layer.

10. The inkjet process of claim 1 wherein the printed image is subjected to firing.

11. The inkjet process of claim 1 wherein the active phase is silver.

12. The inkjet process of claim 1 wherein the ink vehicle contains two or more solvents, each having a different volatility.

13. The inkjet process of claim 1 wherein substrate is glass, ceramic, plastic or metal.

14. The inkjet process of claim 1 wherein the width of the line is less than 100 micrometers.

15. The inkjet process of claim 1 wherein the width of the line is less than 50 micrometers.

16. The inkjet process of claim 1 wherein the rate of delivery of ink printed in subsequent layers is higher than the rate of delivery of in the initial layer.

17. The inkjet process of claim 1 wherein the ink composition comprises at least 20% by weight of an active phase.

18. An article manufactured by a process comprising
a) preparing an ink composition comprising an ink vehicle and at least 10% by weight of an active phase;
b) printing said ink composition dropwise onto a non-absorbent substrate in an initial layer in such a manner that;
i. in the initial layer the individual droplets do not substantially overlap one another; and
ii. the droplets at least partially dry before printing subsequent layers; and
c) printing one or more subsequent layers in a dropwise manner such that the droplets in the first said subsequent layer are offset from the droplets of the initial layer and connect the droplets of the initial layer to form a continuous network;
d) and forming said article.

19. The article of claim 18 wherein the article is a display device, a piezoelectric device, a digitizer tablet, a touch screen, electromagnetic interference shielding, or a piezoelectric motor.

20. The article of claim 19 wherein the display device is a plasma display panel, a field emission display, or a liquid crystal display.

21. The article of claim 19 wherein the piezoelectric device is a radio frequency band pass filter, surface acoustic wave radio frequency identification tag, duplexer, clock oscillator, crystal resonator; fuel level sensor, dry powder level sensor, or impact detector.

22. The article of claim 18 wherein the image is conducting.

23. A printing system for producing printed images comprising:
a) an ink composition comprising an ink vehicle and at least 10% by weight of an active phase;
b) a host device to digitally store and processes the image to be printed; and
c) a printing device comprising an input device, printer controller, print mechanism, transport device, print cartridge, and printhead; said printhead and print cartridge containing said inkjet ink composition, said inkjet printing device configured to print said ink composition onto a non-absorbent substrate in multiple layers such that;
i. in the initial layer the individual droplets do not substantially overlap one another; and
ii. the droplets at least partially dry before printing subsequent layers; and
iii. one or more subsequent layers are printed in a dropwise manner such that the droplets in the first said subsequent layer are offset from the droplets of the initial layer and connect the droplets of the initial layer to form a continuous network.

24. The printing system of claim 23 wherein the printhead is a piezoelectric device.

25. The printing system of claim 23 wherein the substrate is fixed and the printhead is translated relative to the substrate.

26. The printing system of claim 23 wherein the printhead is fixed and the substrate is translated relative to the printhead.

27. The printing system of claim 23 wherein there is a plurality of independently controlled printheads.
